(19) United States
(12) Patent Application Publication
(10) Pub. No.: US 2007/0099631 A1
(43) Pub. Date: May 3, 2007

(54) Communication mode switching system and method for the same

(75) Inventors: Cheng-Shing Lai, Taipei (TW); Xiao-Long Fan, Nanking City (CN); Li-Chun Yen, Taipei (TW)

Correspondence Address: BIRCH STEWART KOLASCH & BIRCH, PO BOX 747, FALLS CHURCH, VA, 22040-0747, US

(73) Assignee: Inventec Appliances Corp.

(21) Appl. No.: 11/588,241

(22) Filed: Oct. 27, 2006

(30) Foreign Application Priority Data
Oct. 28, 2005 (TW) 94137953

(51) Int. Cl. H04Q 7/20

(52) U.S. Cl. 455/456.1

(57) ABSTRACT

The invention is related to a communication mode switching system for uses in switching communication mode based on position information in a mobile communication apparatus and a method thereof. The system includes a database, a positioning module, a communication module, and a processing module. The database is for storing communication modes, parameters of the communication modes, and a correspondence table of the relationships between the communication modes and position information of the mobile communication apparatus. The positioning module is for calculating the position information. The communication module is for controlling operation of the mobile communication apparatus based on the parameters of the communication modes. The processing module is for comparing the position information with the correspondence table to obtain the corresponding communication mode corresponding to the position information, and updating the parameters of the corresponding communication mode to the communication module.

### BACKGROUND OF THE INVENTION

(1) Field of the Invention

The invention relates to a communication mode switching system and a method thereof, and more particularly to a system and a method that can alter the communication mode according to position information of a mobile communication apparatus.

(2) Description of the Prior Art

Currently, most of mobile communication apparatuses have mode switching functions. Users can switch around various communication modes to determine a proper one that most suitable for the environment. Yet, in the case that a proper communication mode is not used due to whatever reasons, ill-communication problems resulted from the misuse of the communication mode may arise to bother the users.

To compensate possible misuse in communication modes, some operation control station have been setup in some fixed locations so as to remote control the mode switch of the neighboring mobile communication apparatuses. Referring to FIG. 1, a conventional setup of an operation control station and the a typical mobile communication apparatus is shown in a block diagram. The communication mode of the mobile communication apparatus 12 can be controlled by the operation control station 11. the operation control station 11 includes a mode controller 13 and a mode broadcaster 14. the mobile communication apparatus 12 includes a mode receiver 15 and a processing unit 16.

In the operation control station 11, the mode controller 13 is used to generate a mode signal 131 that is then forwarded to the mode broadcaster 14. The mode signal 131 can be contains setup by an operation end, or built-in data of the mode controller 13. The mode broadcaster 14 is used to encode the incoming mode signal 131 into a radio signal 141 that is further forwarded wirelessly to the mode receiver 15 of the mobile communication apparatus 12.

In the mobile communication apparatus 12, the mode receiver 15 is used to decode the radio signal 141 back into the mode signal 131 that is further forwarded to the processing unit 16. After receiving the mode signal 131, the processing unit 16 can then switch its communication mode.

In the aforesaid art, the communication mode of the mobile communication apparatus 12 is remotely switched and controlled by the operation control station 11. However, such a switching is possible if and only if the mobile communication apparatus 12 is located adjacent at a limit distance to the operation control station 11. That is to say that, if the mobile communication apparatus 12 is operated beyond the work region of the operation control station, the mode switching would never happen to the mobile communication apparatus 12 even that the mode switch is urgent needed.

Therefore, a more convenient and less location-oriented communication mode switching system and its application method are definitely welcome to the ordinary skilled person in the art.

### SUMMARY OF THE INVENTION

Accordingly, an object of the present invention is to provide a communication mode switching system and a method thereof. In particular, the mobile communication apparatus utilizing the system can determine a proper communication mode based on its position information.

In the present invention, the communication mode switching system is applicable to most of the mobile communication apparatuses for switching the operational communication mode. The communication mode switching system comprises a database, a positioning module, a communication module, and a processing module. The database is for storing at least a communication mode, parameters of the communication mode. The correspondence table is for providing mapping relationships between the communication modes and the position information. The positioning module is for receiving a radio signal, for example, the radio signal from satellites of the global position system (GPS), for further calculating the current position information of the concerned mobile communication apparatus. The processing module for comparing the position information with the correspondence table to obtain the communication mode corresponding to the position information. After the proper communication mode is determined, the corresponding parameters are updated to the communication module so as to further direct the mobile communication apparatus to switch to the proper communication mode.

All these objects are achieved by the communication mode switching system and the method thereof described below.

### BRIEF DESCRIPTION OF THE DRAWINGS

The present invention will now be specified with reference to its preferred embodiment illustrated in the drawings, in which:

FIG. 1 is a schematic view of a conventional operation control station and a typical mobile communication apparatus;

FIG. 2 is a schematic view of a preferred embodiment of the communication mode switching system in accordance with the present invention;

FIG. 3 is a flowchart of a preferred embodiment of the method for the communication mode switching system of FIG. 2;

FIG. 4 is a flowchart of a preferred embodiment of the communication mode of blocking incoming calls in accordance with the present invention; and

FIG. 5 is a flowchart of a preferred embodiment of the communication mode of answering automatically the incoming messages in accordance with the present invention.

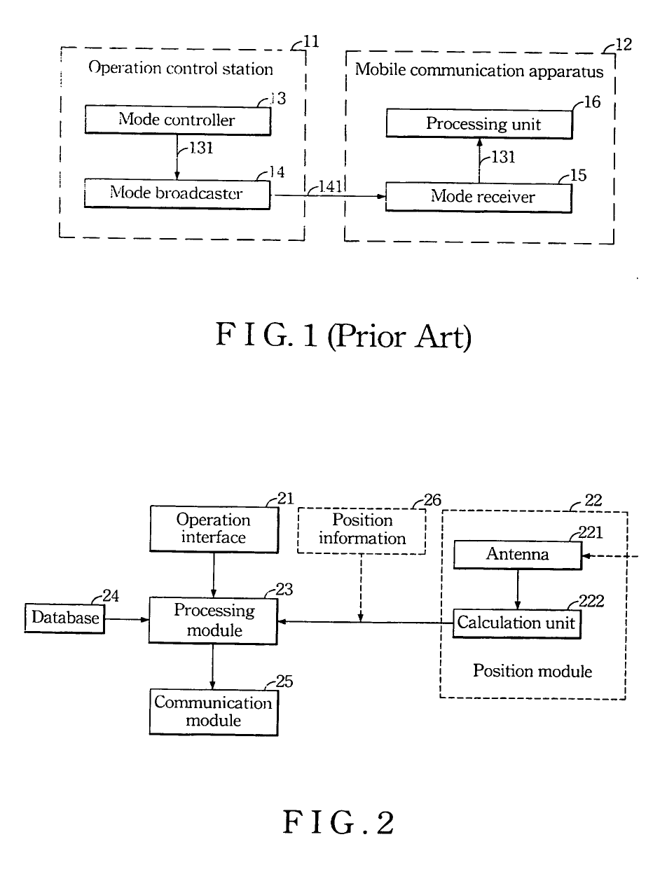

### DESCRIPTION OF THE PREFERRED EMBODIMENT

The invention disclosed herein is directed to a communication mode switching system and a method thereof. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

Referring now to FIG. 2, a preferred embodiment of the communication mode switching system in accordance with the present invention is shown. The communication mode switching system is applicable to most of mobile communication apparatuses for switching their operational communication modes. As shown, the communication mode switching system comprises an operation interface 21, a positioning module 22, a processing module 23, a database 24, and a communication module 25. The operation interface 21 is provided to the users for setting up various communication modes and respective parameters for those communication modes, and also for determining correspondence table for elucidating the mapping relationships between position information and the communication modes. The positioning module 22 can comprise an antenna 221 and a calculation unit 222. The antenna 221 is for receiving a radio signal, for example, the radio signal from satellites of the global position system (GPS), for further calculating the position information 26 of the mobile communication apparatus. The position information 26 is further provided to the processing module 23. For the technique of obtaining the position information 26 from the positioning module 22 is a technique well known to an ordinary skilled person in the art and also not the topic of the present invention, details regarding such a technique are omitted herein. The processing module 23 stores the correspondence table, the communication modes and the respective parameters, setup by the users through the operation interface 21, into the database 24 to complete the fore-setup procedure.

Furthermore, the processing module 23 compares the position information 26 of the concerned mobile communication mode with the correspondence table stored in the database 24 so as to obtain a proper or optimal communication mode. After the proper communication mode is determined, the corresponding parameters are retrieved from the database 24 and further updated to the communication module 25. In the present invention, the database 24 can also be used to store various brief messages that may be forwarded to the communication module 25 along with the communication modes. The processing module 23 can update the parameters of the proper communication mode to the communication module 25, and then the communication module 25 directs the operation of the mobile communication apparatus in accordance with the new parameters of its updated communication mode. In the present invention, the communication modes for switching comprise a mode of stopping any dialing of the mobile communication apparatus, a mode of limiting dialing to specific calling parties, a mode of limiting specific calling patterns, a mode of blocking all the incoming calls, a mode of accepting only specific incoming calls, a mode of accepting only specific calling patterns, a mode of forwarding the incoming calls, a mode of answering automatically the incoming messages, a mode of sending automatically the outgoing messages, a mode of switching to a vibration mode, and a mode of switching to a silent mode, of the mobile communication apparatus.

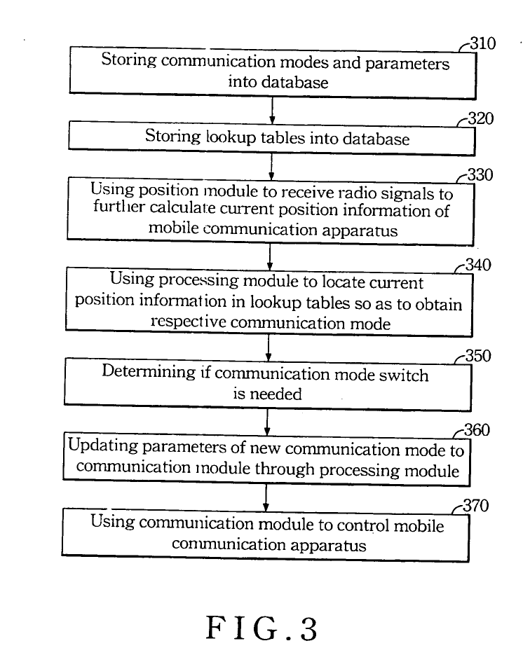

Referring now to FIG. 3, a flowchart of a preferred embodiment of the method for the communication mode switching system in accordance with the present invention is shown. The method comprises the step of:

Step 310: Storing communication modes and parameters for the communication modes into a database;

Step 320: Storing a correspondence table into the database, wherein the correspondence table elucidate mapping relationships between the communication modes and the position information;

Step 330: Receiving a radio signal and further calculating the current position information of the mobile communication apparatus;

Step 340: comparing the current position information with correspondence table to obtain the corresponding communication mode corresponding to the position information;

Step 350: Determining whether a communication mode is needed to be switched;

Step 360: Updating the corresponding parameters of the new communication mode into a communication module; and

Step 370: Controlling the mobile communication apparatus based on the parameters of the corresponding communication mode.

In the foregoing procedures, the radio signals for determining the position information can be provided by satellites of the GPS. In the present invention, the method can further comprise a step of setting up the communication modes and the respective parameters of the communication modes. In addition, the method can further comprise a step of setting the relationship between the communication mode and the position information into the correspondence table.

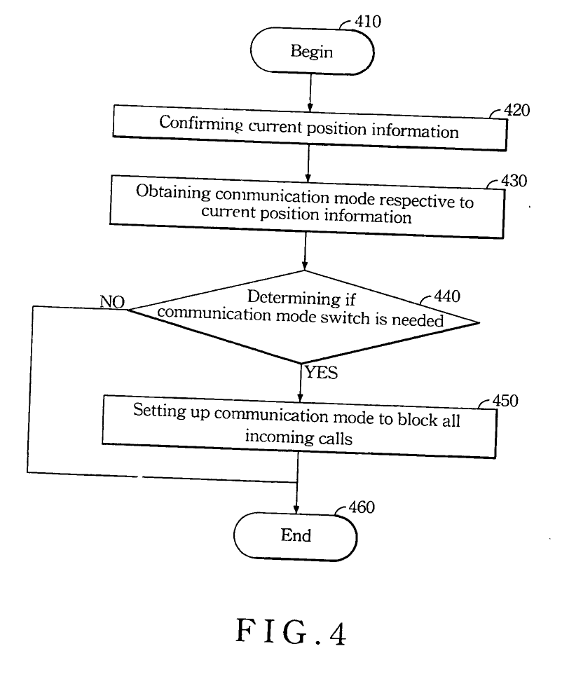

Referring now to FIG. 4, a flowchart of a preferred embodiment of the communication mode of blocking incoming calls of the method in accordance with the present invention is shown. Switching of this communication mode includes the steps of:

Step 410: Begin;

Step 420: Confirming the current position information;

Step 430: Obtaining a communication mode respective to the current position information;

Step 440: Determining whether a communication mode is needed to be switched;

Step 450: Setting up the communication mode to block all incoming calls; and

Step 460: End.

In the foregoing procedures, the user end can refer the mode of blocking all incoming calls to some specific locations such as libraries, conference room, and so on in the correspondence table.

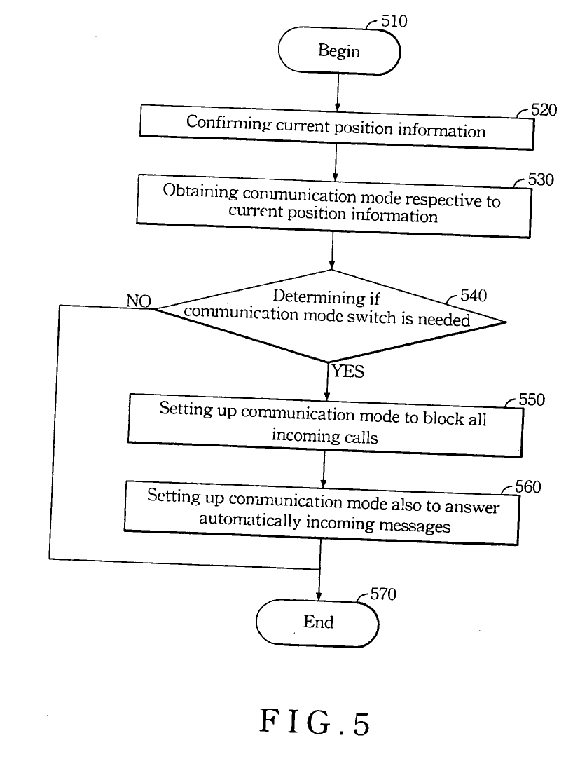

Referring now to FIG. 5, a flowchart of a preferred embodiment of the communication mode of answering automatically the incoming messages of the method in accordance with the present invention is shown. Switching of this communication mode includes the steps of:

Step 510: Begin;

Step 520: Confirming the current position information;

Step 530: Obtaining a communication mode respective to the current position information;

Step 540: Determining whether a communication mode is needed to be switched;

Step 550: Setting up the communication mode to block all incoming calls;

Step 560: Setting up the communication mode also to answer automatically the incoming messages; and

Step 570: End.

In the foregoing procedures, the user end can refer the mode of answering automatically all the incoming messages to some specific locations such as libraries, conference room, and so on in the correspondence table so as to avoid possible bothering of incoming calls but inform the calling ends that the response calls can be expected late on or that the receiving end is busy.

In the present invention, a specific mode of sending automatically messages to a specific end can be included, which can be applicable to the mobile communication apparatus carried by kids. In such an application, the receiving end can be the kids' parents, and the specific positions may include schools, extension education units, homes and so on. As soon as the kids arrive any of the aforesaid positions, the communication mode switching system of the present invention would immediately send messages to their parents to inform their safety arrival.

While the present invention has been particularly shown and described with reference to a preferred embodiment, it will be understood by those skilled in the art that various changes in form and detail may be without departing from the spirit and scope of the present invention.

I claim:

1. A communication mode switching system for switching a communication mode of a mobile communication apparatus, comprising:
a database for storing at least a communication mode, parameters of the communication mode, and a correspondence table of the relationships between the communication mode and position information of the mobile communication apparatus;
a positioning module for calculating the position information of the mobile communication apparatus based on a received radio signal;
a communication module for controlling operation of the mobile communication apparatus based on the parameters of the communication modes; and
a processing module for comparing the position information with the correspondence table to obtain the communication mode corresponding to the position information, and updating the parameters of the communication mode to the communication module.

2. The communication mode switching system according to claim 1, further comprising an operation interface for setting up said parameters of communication mode.

3. The communication mode switching system according to claim 1, further comprising an operation interface for setting up said relationships between said communication mode and said position information.

4. The communication mode switching system according to claim 1, wherein said radio signal is provided by a satellite of a global position system.

5. The communication mode switching system according to claim 1, wherein said communication mode comprising a mode of stopping any dialing of said mobile communication apparatus, a mode of limiting dialing to specific calling parties, a mode of limiting specific calling patterns, a mode of blocking all incoming calls, a mode of accepting only specific incoming calls, a mode of accepting only specific calling patterns, a mode of forwarding incoming calls, a mode of answering automatically incoming messages, a mode of sending automatically outgoing messages, a mode of switching to a vibration mode, and a mode of switching to a silent mode, of said mobile communication apparatus.

6. A method for switching a communication mode of a mobile communication apparatus, comprising the step of:
storing at least a communication mode, parameters for the communication mode, and a correspondence table into a database, wherein the correspondence table comprises the relationships between the communication mode and position information of mobile communication apparatus;
receiving a radio signal and further calculating the current position information of the mobile communication apparatus;
comparing the current position information with correspondence table to obtain the corresponding communication mode corresponding to the position information; and
controlling the mobile communication apparatus based on the parameters of the corresponding communication mode.

7. The method for switching a communication mode according to claim 6, further comprising a step of setting up said parameters of said communication mode.

8. The method for switching a communication mode according to claim 6, further comprising a step of setting up said relationships between said communication mode and said position information.

9. The method for switching a communication mode according to claim 6, wherein said radio signal is provided by a satellite of a global position system.

10. The method for switching a communication mode according to claim 6, wherein said communication mode comprising a mode of stopping any dialing, a mode of limiting dialing to specific calling parties, a mode of limiting specific calling patterns, a mode of blocking all incoming calls, a mode of accepting only specific incoming calls, a mode of accepting only specific calling patterns, a mode of forwarding incoming calls, a mode of answering automatically incoming messages, a mode of sending automatically outgoing messages, a mode of switching to a vibration mode, and a mode of switching to a silent mode, of said mobile communication apparatus.
